(19) United States
(12) Patent Application Publication
(10) Pub. No.: US 2004/0205643 A1
(43) Pub. Date: Oct. 14, 2004

(54) Reproduction of documents using intent information

(76) Inventor: Steven J. Harrington, Webster, NY (US)

Correspondence Address: John E. Beck, Xerox Corporation, Xerox Square 20A, Rochester, NY, 14644, US

(21) Appl. No.: 09/733,385

(22) Filed: Dec. 4, 2000

Related U.S. Application Data
(60) Provisional application No. 60/213,500, filed on Jun. 22, 2000.

(51) Int. Cl. G06F 3/14

(52) U.S. Cl. 715/530; 715/526

(57) ABSTRACT

In a document processing device, reproduction of documents in a variety of modes or formats is aided by describing a document as a combination of document data and a document intent vector, associated with a created document to support document processing. The document intent vector captures high-level intent information such as the desire to attract attention, to limit costs, or to convey information effectively. Each component of the vector expresses the degree of intention along an intent dimension. The components are continuous numerical values allowing the vector to represent a continuum of intent expressions. The overall intent is a point in the intent space as expressed by the vector.

This application is based on a provisional application No. 60/213,500, filed Jun. 22, 2000.

The present invention describes a document processing system wherein the creator's intentions are captured in a quantified form and included with the document description for use in processing the document and more particularly, how the intents can be defined in terms of measurable document value properties.

The expression of intention is common in document design. Different documents can have quite different appearance depending on the intentions of the creator. However, these intentions are typically implicit within the document and are rarely expressed. Even when they are expressed they are usually conveyed as loosely defined qualitative concepts and not in any hard quantitative terms. Intents, as used herein can be thought as the reasons behind the decisions made. It is these decisions that give the document different appearances according to the intents.

Many decisions are made in the creation and presentation of a document. Such decisions can be made at all stages of processing and the choices reflect the creator's intentions for the document. The choices provide the best effort to satisfy the creator's intentions for the expected audience and presentation device. Choices include the selection of content elements, the specification of style values (such as color and font), the layout of the content elements (such as the number of columns and line spacing) and the rendering of the document (such as gamut mapping and halftoning method). The fact that there are choices implies that in some circumstances some decisions are appropriate, while in other circumstances different choices are better.

A designer typically makes a particular choice in order to improve some property of the document. Examples of design choices include making it more visually balanced, making it easier to read, making it less expensive to produce, making it more eye-catching. If the good or desirable properties could all be simultaneously optimized, there would be no need for decisions. However, enhancing some properties reduces others. Certain document design intent, then, is also expressed in the relative importance of the various properties.

The Internet is driving a change in the document design process, due to new uses of documents generated and reused. In the old work process, the document creator constructed and printed a document. The printed copies of the document were then distributed to the audience. The creator had full control of the document appearance. Today, however, a document may be created and then distributed in electronic form; or it may be posted on the World Wide Web and then downloaded to the viewer. The final presentation will be made on a device of the viewer's choice. This may be a printer, or CRT or LCD display screen. It can be of any size and shape from a room-sized projection to a pocket PDA screen. It might even be converted to speech and read through a phone.

The decisions made for one output device may not be appropriate for a different output device. For example, employing color would not be effective for a black-and-white printer, or the layout decisions may be irrelevant if the document is converted to speech.

Current efforts to deal with this problem have largely been attempts to make the old approach work for the new work process. One attempt is to try to make all output devices behave alike. This is the approach taken by Adobe's PDF file format. The problem is that all devices are not alike, and a document designer may end up creating a common denominator presentation that is not optimal for any output device.

Another approach is seen in the development of style sheets such as CSS for HTML and XSL for XML. This is a separation of document style from document content and allows the creator to specify more than one style for the document. The creator can use this feature to construct separate presentation styles for different target display devices. The problem is that the creator cannot anticipate all possible presentation devices and usually would rather not have to try.

Because the creator can no longer control the choice of presentation device, it is no longer appropriate to make all of the decisions at the time of creation. At least some of the decisions should be left to the time of presentation, when information on the audience and presentation device is available. But processing a document at that time, will require information about the creator's intentions. The creator's goals for the document must somehow be retained in order to reprocess the document effectively. These goals should be explicitly captured and expressed as metadata associated with the document. We call this metadata the document intents.

There have been some previous efforts at capturing intent information. The HTML document description has, for example, the mark-up tags <strong> and <emphasis> that can be use instead of the explicit formatting of <bold> and <italic>. The International Color Consortium color standard specifies “color rendering intents” that tag colors as “absolute”, “relative”, “saturation” or “perceptual” (See Specification ICC.1:1998-09). These tags can aid in decisions about the color processing such as the choice of gamut mapping method. Hints and tags have also been associated with document components to aid in rendering including Xerox object optimized rendering (U.S. Pat. No. 6,006,013) and techniques from Hewlett-Packard (U.S. Pat. No. 5,579,446).

These previous methods have shortcomings. They are targeted towards particular decisions at particular stages of processing. And furthermore, they are qualitative, rather than quantitative. This is like saying something is red without describing the degree of intensity, strength, or tendency towards orange or violet. There is no numerical definition so things are not well defined, nor can they be reproduced, transformed, or even easily manipulated.

### SUMMARY OF THE INVENTION

The present invention is directed to a process of document creation and subsequent reproduction, in which quantitative values of document intents are generated and used.

In accordance with one aspect of the invention there is provided a document intent vector, associated with a created document to support document processing. The intent vector captures high-level intent information such as the desire to attract attention, to limit costs, or to convey information effectively. Each component of the vector expresses the degree of intention along an intent dimension. The components are continuous numerical values allowing the vector to represent a continuum of intent expressions. The overall intent is a point in the intent space as expressed by the vector. Note that unlike prior art, the intents do not directly provide hints for the decisions that must be made.

These and other aspects of the invention will become apparent from the following descriptions to illustrate a preferred embodiment of the invention read in conjunction with the accompanying drawings in which:

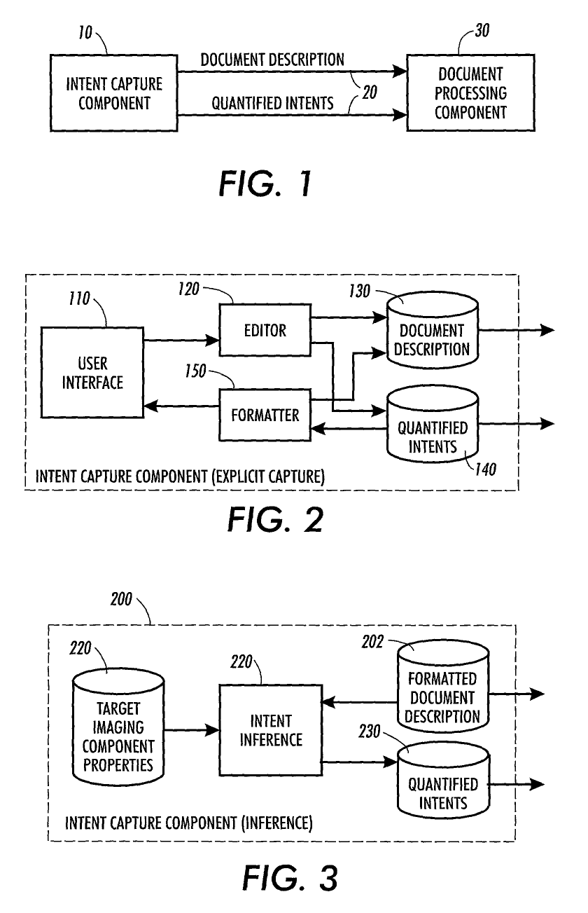

FIG. 1 illustrates the principle of the invention, i.e., a document intent capture component provides as an output the document description or content, together with quantitative document intent information;

FIG. 2 is a simplified illustration of a document intent capture component, in accordance with the invention, set up for explicit capture of document intent information;

FIG. 3 is a simplified illustration of a document intent capture component, in accordance with another aspect of the invention, set up for implicit capture of document intent information;

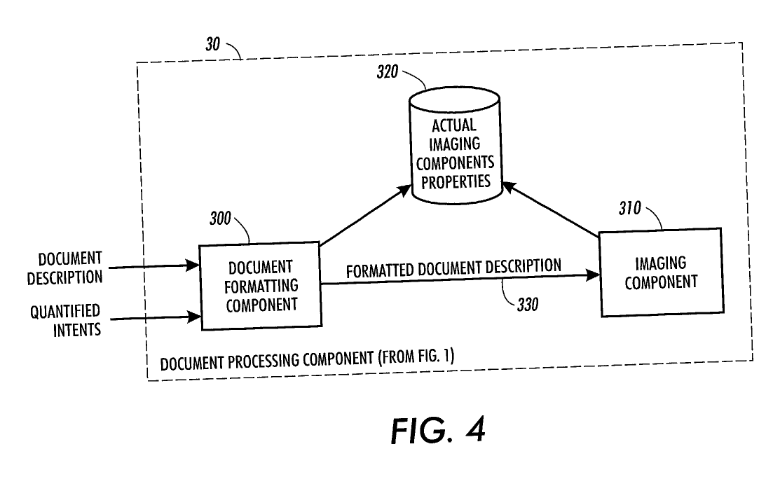

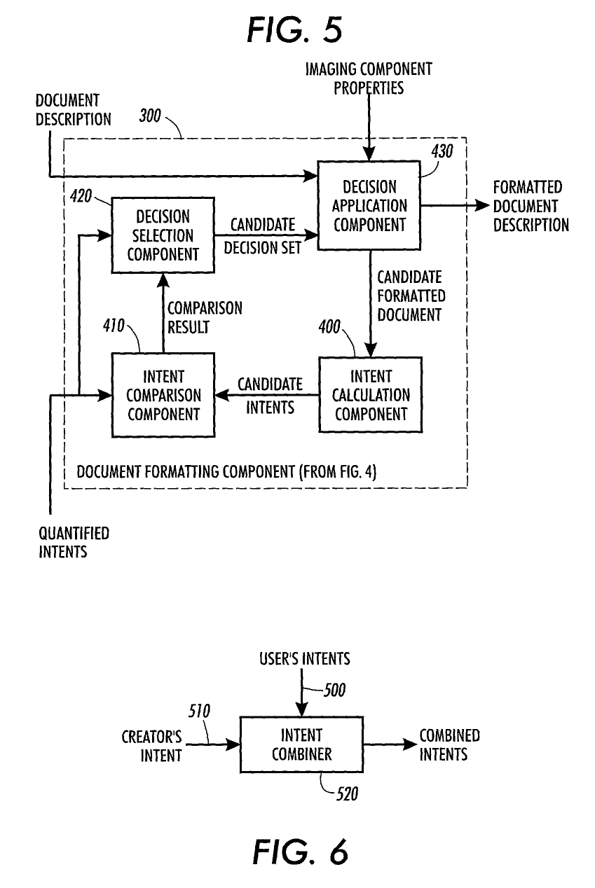

FIG. 4 is a simplified illustration of a document processing component which uses document intent information in accordance with the invention;

FIG. 5 is a simplified illustration of a document formatting component, as shown for example in FIG. 4, which processes intent vector information for a document processing component; and

FIG. 6 is a schematic depiction of a combiner for user intents and creator intents.

Referring now to the drawings where the showings are for the purpose of describing an embodiment of the invention and not for limiting same, a basic document processing system using document intent information is shown in FIG. 1. Initially, however, the principles of the invention will be discussed.

There are many value properties (design elements that, for a particular document may be thought of that of as good or bad) associated with document design. Where there are multiple value properties associated a design element, a choice between at least two such properties is associated with each design decision. Over 100 possible value properties have been identified that are commonly used in design. These value properties can be measured, and a value function can be calculated to produce a measure of the property. It is these measurable value properties that allow the quantification of document intents. There is a functional relationship between intents and value properties that can be approximated as linear. There is thus a matrix A of weights that give the contribution of each value property to each intent coordinate, illustrated by:

I=AV

This relationship can be used to define the intents for both their inference and their application. To infer the intents associated with a document or document component, initially, the value functions associated with the document or component can be calculated. The vector of values V can then be multiplied by the matrix of weights A to obtain the quantified intents vector I.

With an intent vector to be used in performing document processing or reproduction, the effect of the decisions made during that processing can be examined. For the various choices of intents and intent values, the resulting effects on the value properties may be determined. Using weight matrix A, the value properties can be converted to an intent vector and compared to the given vector of desired intents. The decision set that minimizes the difference between the given and inferred intent vectors is the best expression of the intent for the document.

Note that the value properties depend not only on the document, but also on the presentation device. For example, the size of font can affect the cost of a printed document because it can affect the number of pieces of paper required. However, if the same document is displayed on a CRT, there are no paper costs to be affected.

In determining the best decisions, and in one possible embodiment, a fast simple approach for analyzing document intents is to consider each decision independently. This reduces the number of choices that are considered, by not considering the choices in combination. For each decision, a determination is made as to which choice yields the value properties that best match the intent. A problem with this approach is that decisions may not act independently on the value properties and intents. For example, the ease of reading a text line depends upon the font family, font size, interline spacing, line length and other factors. If ease of reading is a significant property for the intent, it may be best to optimize these decisions collectively. It can be noted that, by using the distance between given and inferred intent vectors as a cost function, well known optimization methods (such as simulated annealing, genetic algorithms, neural networks and the like) can be used to solve for the decisions.

As an example of the definition and use of document intents, consider the example of a single page advertisement. The creator's intention is to advertise, but this is a nebulous, qualitative concept. However, clear and quantifiable document intent can be defined in terms of the measurable value properties such as how strongly the document attracts attention, and how well it communicates information. The determination of the value properties depends upon the presentation device. If the creator had a CRT display in mind when the document was created, then blinking behavior might have been given to an element to make it strongly attract attention. The text may need to be fairly large to achieve moderate legibility on that device, to communicate effectively. The intention to advertise would be expressed in the high attention factor relative to a moderate communication ability. If that same document is to be printed, then blinking behavior is no longer an option. Further, since printed text is more legible, the size of the text in the original design is larger than necessary for moderate communicability. If the creator intentions are to be preserved, then different decisions should be made. For example, the formerly blinking element could be made larger and slightly separated from the other elements to make it more noticeable, and to attract attention. The text can be made smaller to make room for the enlarged element since it will still be communicated as effectively.

A system to carry out the document intent preservation when printing the document would work as follows: the document intents would be associated with the document. This could be done by explicit designation and capture of the intent during the document creation. Alternatively, or in combination, it could be accomplished by inference of the intent from the value properties that can be calculated from the document description and the properties of the presentation device for which it was designed or by inference from measurement of values associated with intents. The associated intents take the form of a vector of real numbers from which target value properties for a presentation device can be determined. In this example, the intent that is defined by the relative importance of the various intention dimensions (e.g. to advertise, to limit cost, to evoke actions, etc.) is captured in the intent vector. The system then examines the decisions available to it and their effect on the value properties for the document on the chosen presentation device. The decisions can be style choices such as the size of the font and/or layout choices such as the text line length and element positioning. For the candidate choices, the value properties can be calculated, and from them an intent vector can be determined. The set of choices that best matches the original intent vector is selected. Alternatively, the desired value properties (such as how strongly to attract attention and how well to communicate) might be calculated from the original intent vector. Then for each decision set, the resulting value properties could be compared to the desired value properties and the decision set that minimizes the value-property differences would be selected.

In some simple cases it may be possible to relate the decisions to the value properties in and analytical way that will allow a mathematical solution for the decisions that give the best match to the desired value properties. For devices where the decisions and properties do not have such a simple relationship, one can enumerate the decision possibilities and select the best set of choices, or one can employ well known iterative, or approximation techniques as mentioned above.

Typically a decision will improve some values at the expense of others. For example, a small font size can make the document more economical by requiring fewer pages, but at the expense of reduced legibility. Choosing a large font size increases the legibility but at the possible expense of more pages. The best decision depends upon what is more important, the legibility or the cost.

With reference again to FIG. 1, at the top level this invention is a document system employing quantified document or document component intents including: a quantified intent capture component 10, which captures explicitly or implicitly document intents; a document representation 20 that includes a document description and an expression of quantified intents; and a document processing component 30 that employs quantified intents (see FIG. 1). Conveniently, these elements can be built into a personal computer, a smart printing device, printer driver software, or the like.

The quantified intents are defined as functions of measurable/calculable value properties of the document or document components.

The measurable/calculable value properties may include at least the legibility, ability to attract attention, cost, processing time, visual balance and colorfulness. Other value properties may be defined and are within the scope of the invention.

With reference to FIG. 2, the intent capture component may operate to provide explicit capture by the document creation application component. In such case, quantified intent values are generated as part of document creation at a user interface 110 (either explicitly or through examples), and are captured at editor 120. As noted, the output of document creation device or editor 120 includes both document content or description (shown stored at device 130), and quantified intent values (shown stored at device 140). Intent values and document description can be directed to a document formatter 150, which provides input to user interface 110 about what the document will look like, about how the document might be changed based on explicit intent values.

With reference to FIG. 3, the intent capture component of FIG. 1, may include inferential intent derivation as well, with intent capture component interface 200. Intent inference is done by calculating the value properties from the formatted document stored at device 202 and the intended device properties. Thus, where knowledge about a target imaging component properties are available at 210, the inference component can operate on a description of a formatted document and the properties of the device for which the document is formatted, via intent inference 220. The inference component calculates value properties from the formatted document in the context of the intended device. Inference component 220 then calculates quantified intents stored at 230 from the value properties determined thereby.

With reference to FIG. 4, the system's document processing component can be a document presentation system that includes document formatting components 300 and imaging components 310. The imaging component 310 can be by a variety of devices including printers, CRT displays, LCD displays, text-to-speech devices and the like. The document-formatting component 300 uses the document description, quantified intents (from the intent capture component 10, as in FIG. 1) and imaging component properties stored at 320 (and derived from the imaging components themselves) to produce a formatted document description 340 suitable for input to the imaging component.

With reference to FIG. 5, document-formatting component 300 might contain an intent calculation component 400, an intent comparison component 410 comparing candidate intents from the intent calculation component 400 and quantified intents from the intent capture component 10. The decision selection component 420 may use the quantified document intents to generate a candidate decision set that is used by the decision application component to create a candidate formatted document. The intent-calculation component 410 calculates a quantified intent vector from the computed value properties. The intent-comparison component 410 compares quantified intents passed to the document-formatting component 300 to the quantified intents calculated by the intent-calculation component 400 and provides the comparison result to the decision selection component 420 for revision or selection of the candidate decisions. The candidate formatted document and imaging component properties are used by the intent-calculation component to determine measurable property values and corresponding candidate intents for the document and document elements.

With reference to FIG. 6, it will be understood intents can also arise from the user of the document, which may be distinct from the intents of the document creator. A document processing system can inquire as to the user's intents 500, perhaps provided at a user interface, and combine or reconcile them with the intents of the creator 510, received as part of the document, prior to using the intents to format or otherwise process the document. The intent combination process, at intent combiner 520 can be as simple as always selecting the users intents over the creators intents, or selecting the creators intents over the users, or a more complicated numerical combination such as averaging can be applied.

The document description, imaging component properties, and candidate decision set corresponding to the decisions finally selected by the decision-selection component are passed to the decision application component for output and presentation to the user of a formatted document description.

It will no doubt be appreciated that the present invention may be accomplished with either software, hardware or combination software-hardware implementations.

The invention has been described with reference to a particular embodiment. Modifications and alterations will occur to others upon reading and understanding this specification. It is intended that all such modifications and alterations are included insofar as they come within the scope of the appended claims or equivalents thereof.

What is claimed is:

1. A data format describing a document, including document data and document intent information said document intent information provided as a set of quantitative values indicative of relative importance of document properties.

2. The data format as described in claim 1, wherein said document intent information quantitative values are formatted as a document intent vector.

3. A document processing system, operative to process documents described in a data format including document data and document intent information, said document processing system including quantitative intent capture capabilities.

4. A document processing system, operative to process documents described in a data format including document data and document intent information, said document processing system providing quantitative intent representation and transmission capabilities.

5. A document processing system, operative to process documents described in a data format including document data and document intent information, said document processing system including quantitative intent-based processing capabilities.

6. A document processing device, operative to process documents described in a data format including document data and quantitative document intent information, said document processing device comparing document processing capabilities with quantitative document intent information to determine optimum processing of said document, whereby creator processing intent is retained.

7. An intent capture device, operative to express documents described in a data format including document data and quantitative document intent information, said intent capture device producing the quantitative document intent information either from interaction with the user or by inference from the documents.

8. A data format describing a document, including document data and document intent information said document intent information provided as a set of values indicative of relative importance of document properties.

9. A document creation system, creating a document described in a data format including document data and quantitative document intent information, including
a user interface, at which document data and quantitative document intent information may be entered and displayed;
a document editor, generating and applying document data and quantitative document intent information to a stored document file;
a document formatter, using said document data and quantitative document intent information to format the document, for subsequent display at said user interface.

10. A system as defined in claim 9, wherein said display at said user interface interactively occurs during document creation.

11. A system as defined in claim 9, wherein during document creation, said user interface displays examples of the effects of examples of quantitative document intent information, which examples are selectable via said user interface to there apply said quantitative document intent information.

12. A document indexing and retrieval system, for storing documents described in a data format including document data and quantitative document intent information, including
a document storage device;
a document indexing system, indexing documents in accordance with quantitative document intent information;
a document retrieval system, retrieving document.

13. A method of formatting a document for use at a document using device, wherein the document includes document data and document intent information,
said document intent information provided as a set of quantitative values indicative of relative importance of document properties;
said document using device using the formatted document in accordance with said document usage capabilities and quantified intents; and
said document formatting for said document using device depending on said document intents.

14. The method as described in claim 13, wherein said formatting provides a closest possible match between effective quantified intents of the formatted documents, formatted for said document using device and said document intent information.

15. The method as defined in claim 14, wherein said effective quantified intents are calculated from measurable intent properties of said formatted document.

16. The method as defined in claim 15, wherein said measurable intent properties of said formatted document depend on formatting decisions resulting from document intent information of the document.

17. The method as defined in claim 13, where the measurable intent properties are dependent on the document using device.

18. A document using system, presenting a document described in a data format including document data and quantitative document intent information, including
a user interface, at which quantitative document intent information may be specified by a document user.

19. A document using system, presenting a document described in a data format including document data, and quantitative document intent information, specified by a document creator including:
a document using system user interface receiving document user quantitative intent information;
a document using system document processor, combining document creator quantitative document intent information, and document user quantitative document intent information, prior to presenting the document.

20. The document using systems defined in claim 19, and wherein the document using system processor applies a set of reconciliation rules to the document creator quantitative document intent information, and document user quantitative document intent information, in order to determine the appropriate combination thereof.
